(19) United States
(12) Patent Application Publication
(10) Pub. No.: US 2026/0125007 A1
(43) Pub. Date: May 7, 2026

(54) MANAGEMENT SYSTEM

(71) Applicant: TOYOTA JIDOSHA KABUSHIKI KAISHA, Toyota-shi (JP)

(72) Inventors: Hidenobu KINUGASA, Nagoya-shi (JP); Takahiro YAMAMOTO, Toyota-shi (JP); Tatsuya SUGANO, Seto-shi (JP)

(73) Assignee: TOYOTA JIDOSHA KABUSHIKI KAISHA, Toyota-shi (JP)

(21) Appl. No.: 19/338,456

(22) Filed: Sep. 24, 2025

(30) Foreign Application Priority Data
Nov. 7, 2024 (JP) 2024-195214

(51) Int. Cl. B60R 16/023; B60W 30/06; B60W 60/00; G06V 20/52

(52) U.S. Cl. CPC B60R 16/0231; G06V 20/52; B60W 30/06; B60W 60/001; B60W 2530/201; B60W 2556/45; G06V 2201/08

(57) ABSTRACT

The management system manages a vehicle in a predetermined area. The management system instructs a target vehicle to execute a plurality of types of actions in a predetermined order. The management system recognizes an action executed by the vehicle within the predetermined area by using a sensor installed in the predetermined area. The management system identifies a vehicle that has executed any one of the types of actions within a determination period after the instruction to the target vehicle, as the target vehicle.

### CROSS-REFERENCE TO RELATED APPLICATION

This application claims priority to Japanese Patent Application No. 2024-195214 filed on Nov. 7, 2024. The disclosure of the above-identified application, including the specification, drawings, and claims, is incorporated by reference herein in its entirety.

### BACKGROUND

### 1. Technical Field

The present disclosure relates to a technology for managing a vehicle in a predetermined area.

### 2. Description of Related Art

U.S. Pat. No. 10,532,771 discloses a technology related to automated valet parking (AVP) in a parking lot. A target vehicle is a vehicle that uses the AVP in the parking lot. A system transmits information instructing the target vehicle to execute a predetermined action. The predetermined action is, for example, blinking of a front light. The system uses a camera installed at a drop-off position of the parking lot to check whether a vehicle stopped at the drop-off position has executed the predetermined action. The system identifies a vehicle that has executed the predetermined action as the target vehicle.

### SUMMARY

A vehicle identification technology for identifying a vehicle that has executed a predetermined action in a predetermined area as a target vehicle is considered. Regarding such a vehicle identification technology, the present inventors have recognized the following problems. That is, in some cases, an action executed by the vehicle cannot be properly recognized depending on the environment. For example, in a case where the action is blinking of light, depending on a degree of lighting, “overexposure” may occur in an image captured by a camera. In a case where the overexposure occurs in the image, there is a possibility that the blinking of the light by the vehicle cannot be correctly detected even though the blinking of the light is performed. In a case where the action executed by the vehicle cannot be properly recognized, the target vehicle cannot be identified.

One object of the present disclosure is to provide a technology capable of increasing a probability that the target vehicle can be identified.

An aspect of the present disclosure relates to a management system that manages a vehicle in a predetermined area.

The management system includes one or more processors.
The one or more processors instruct the target vehicle to execute a plurality of types of actions in a predetermined order.
The one or more processors recognize an action executed by a vehicle within a predetermined area by using a sensor installed in the predetermined area.
The one or more processors identify a vehicle that has executed any one of the types of actions within a determination period after the instruction to the target vehicle, as the target vehicle.

According to the present disclosure, the target vehicle is instructed to execute the types of actions in the predetermined order. Then, the vehicle that has executed any one of the types of actions is identified as the target vehicle. Even though a certain action is difficult to recognize under a certain environment, another action is likely to be easily recognized. That is, in any environment, at least any one of the types of actions is highly likely to be recognized. Therefore, the probability that the target vehicle can be identified is increased.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram for describing an example of vehicle control in a predetermined area;

FIG. 2 is a conceptual diagram for describing a basic vehicle identification processing;

FIG. 3 is a conceptual diagram for describing an outline of the vehicle identification processing based on a plurality of types of actions;

FIG. 4 is a conceptual diagram for describing an example of a method of deciding the types of actions;

FIG. 5 is a conceptual diagram for describing an example of an order of the types of actions; and

FIG. 6 is a block diagram showing a configuration example of the management system.

### DETAILED DESCRIPTION OF EMBODIMENTS

Embodiments of the present disclosure will be described with reference to the accompanying drawings.

### 1. Vehicle Control in Predetermined Area

Consider the control of a vehicle 1 in a predetermined area AR. Examples of the predetermined area AR include a parking lot, a factory, a site of a facility, and a city (smart city). In the predetermined area AR, the vehicle 1 is controlled to travel to a set destination. The vehicle 1 may be an autonomous driving vehicle.

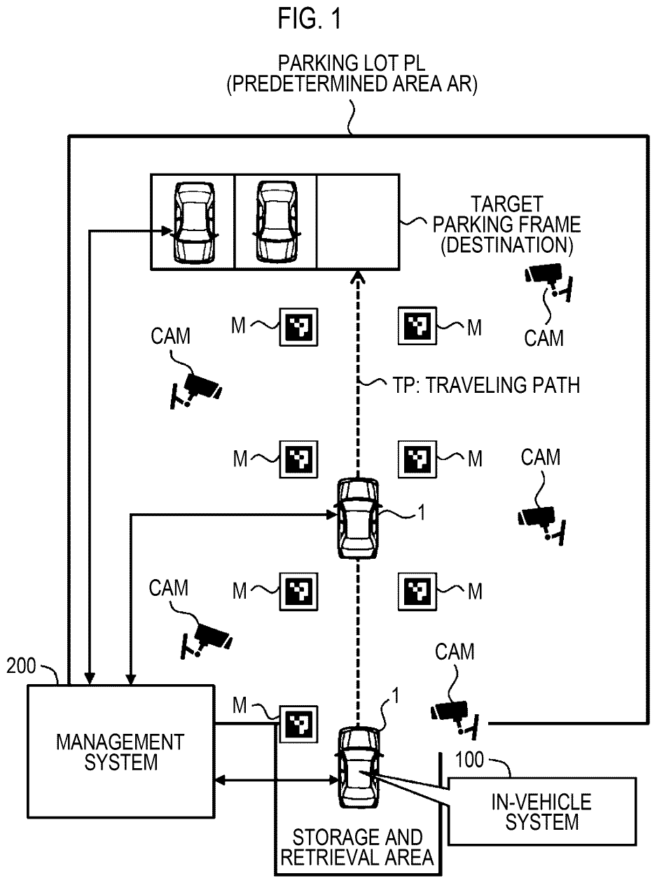

FIG. 1 is a conceptual diagram for describing an example of control of the vehicle 1 in the predetermined area AR. In the example shown in FIG. 1, the predetermined area AR is a parking lot PL. The parking lot PL provides an automated valet parking (AVP) service. The vehicle 1 is equipped with a function of performing automated valet parking, and can autonomously drive at least in the parking lot PL.

An in-vehicle system 100 is mounted on the vehicle 1 and controls the vehicle 1. Specifically, the in-vehicle system 100 recognizes a situation around the vehicle 1 by using a recognition sensor (for example, a camera) mounted on the vehicle 1. The in-vehicle system 100 causes the vehicle 1 to travel safely while a situation around the vehicle 1 is recognized. A plurality of markers M (landmarks) may be disposed in the parking lot PL. The marker M is used to guide the vehicle 1 in the parking lot PL. For example, the in-vehicle system 100 acquires the surrounding image using a camera and recognizes the marker M based on the image. Then, the in-vehicle system 100 performs a localization process for estimating the position of the vehicle 1 in the parking lot PL with high accuracy based on the recognition result of the marker M. The in-vehicle system 100 causes the vehicle 1 to autonomously drive within the parking lot PL based on the estimated vehicle position.

The management system 200 is a system that manages the parking lot PL (predetermined area AR) and the automated valet parking, and is disposed outside the vehicle 1. The management system 200 can communicate with each vehicle 1 in the parking lot PL. For example, the management system 200 communicates with each vehicle 1 in the parking lot PL via the wireless LAN. The management system 200 may remotely operate each vehicle 1 in the parking lot PL.

One or more infrastructure cameras CAM may be installed in the parking lot PL. The infrastructure camera CAM captures the parking lot PL and acquires an image indicating the situation of the parking lot PL. The management system 200 communicates with the infrastructure camera CAM to acquire an image captured by the infrastructure camera CAM. The management system 200 detects the vehicle 1 reflected in the image by analyzing the image. In addition, the management system 200 estimates the position of the vehicle 1 reflected in the image. Further, the management system 200 manages the vehicle 1 in the parking lot PL based on the position of the vehicle 1. The management system 200 may provide the position information of the vehicle 1 to the vehicle 1. The in-vehicle system 100 of the vehicle 1 may cause the vehicle 1 within the parking lot PL to autonomously drive based on the position information provided from the management system 200.

The processing of the vehicle storage is as follows. The vehicle 1 stops in the vehicle storage area. The management system 200 allocates the empty parking frame to the vehicle 1. The assigned vacant parking frame is the target parking frame, that is, the destination for the vehicle 1 at the time of vehicle storage. Further, the management system 200 sets a target trajectory (traveling path TP) from the vehicle storage area to the target parking frame in the parking lot PL. The in-vehicle system 100 acquires information on a target trajectory to a target parking frame. The management system 200 issues an instruction to the in-vehicle system 100 to store the vehicle. In response to the vehicle storage instruction, the in-vehicle system 100 causes the vehicle 1 to travel to the target parking frame in accordance with the target trajectory. That is, the in-vehicle system 100 controls the vehicle 1 to follow the target trajectory based on the vehicle position. The in-vehicle system 100 causes the vehicle 1 to be parked in the target parking frame.

The vehicle retrieval processing is as follows. At the time when the vehicle 1 is retrieved, the designated vehicle retrieval area is the destination for the vehicle 1. The management system 200 sets a target trajectory (traveling path TP) from the parking frame to the vehicle retrieval area in the parking lot PL. The in-vehicle system 100 acquires information on a target trajectory to a vehicle retrieval area. The management system 200 issues a vehicle retrieval instruction to the in-vehicle system 100. In response to the vehicle retrieval instruction, the in-vehicle system 100 causes the vehicle 1 to travel to the vehicle retrieval area in accordance with the target trajectory. That is, the in-vehicle system 100 controls the vehicle 1 to follow the target trajectory based on the vehicle position. The in-vehicle system 100 causes the vehicle 1 to stop in a vehicle retrieval area.

### 2. Vehicle Identification Processing

Consider identifying a specific vehicle 1 in the predetermined area AR. The vehicle 1 to be identified is hereinafter referred to as a “target vehicle 1T”. In addition, the processing of identifying the target vehicle 1T in the predetermined area AR is hereinafter referred to as “vehicle identification processing”.

For example, in a case where the predetermined area AR is the parking lot PL that provides the AVP service as shown in FIG. 1, the target vehicle 1T is the vehicle that tries to perform vehicle storage by using the AVP service. For example, in a case where the first vehicle of the first user tries to perform vehicle storage using the AVP service, the first vehicle is the target vehicle 1T. More specifically, the first vehicle of the first user is stopped in the vehicle storage area, and the first user gets off the first vehicle. The operation permission of the first vehicle is transferred from the first user to the management system 200 (referred to as handover). The management system 200 communicates with the first vehicle to start the first vehicle. Here, in a case where the AVP for the first vehicle is started, the management system 200 desirably accurately recognizes which vehicle 1 in the vehicle storage area is the first vehicle. That is, the management system 200 is desired to identify the first vehicle (target vehicle 1T). By identifying the first vehicle, it is possible to accurately recognize the position of the first vehicle, that is, the autonomous driving start position. In addition, it is possible to prevent the vehicle 1 that is not the first vehicle from mistakenly performing vehicle storage.

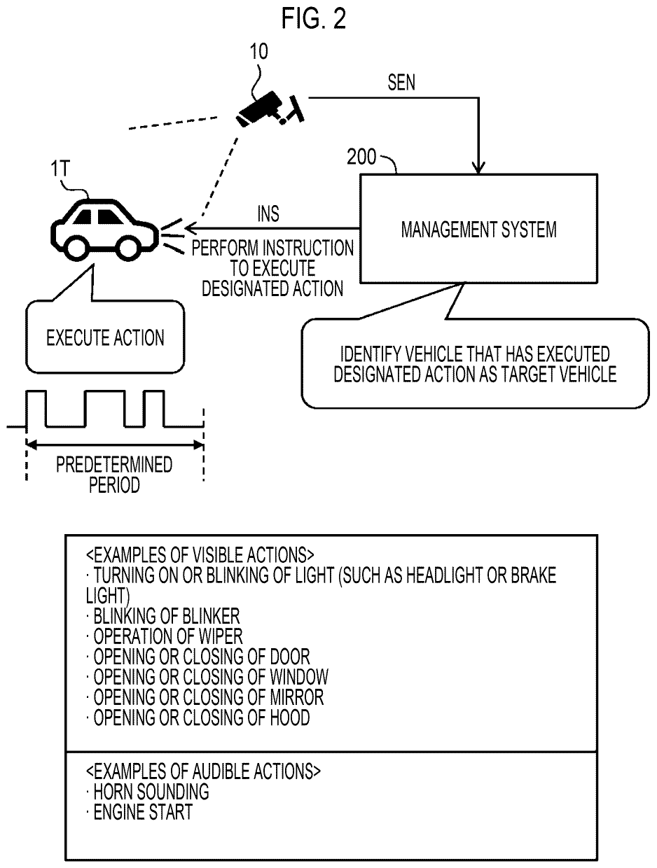

FIG. 2 is a conceptual diagram for describing a basic vehicle identification processing. In the present embodiment, the “action” executed by the target vehicle 1T is used for the vehicle identification processing.

The action is defined by a combination of a device that executes the action and an operation pattern of the device. Examples of the device that executes the action include a light, a blinker (direction indicator), a wiper, an actuator, an engine, and a horn. Examples of the light include a headlight, a brake light, and a fog light. Examples of the actuator include a door actuator that automatically opens and closes a door, a window actuator that automatically opens and closes a window, a mirror actuator that automatically opens and closes a door mirror, a hood actuator that automatically opens and closes a hood, and the like.

Examples of the visible action include turning on or blinking of a light, blinking of a blinker, operation of a wiper, opening or closing of a door, opening or closing of a window, opening or closing of a door mirror, and opening or closing of a hood. Examples of the audible action include horn sounding and engine running. For example, a headlight or a blinker blinks in a predetermined pattern for a predetermined period (for example, several seconds). As another example, the door mirror may be opened and closed in a predetermined pattern within a predetermined period. As still another example, the horn may sound in a predetermined pattern for a predetermined period. The action of the predetermined pattern may be repeatedly executed in time.

The management system 200 communicates with the target vehicle 1T within the predetermined area AR. Then, the management system 200 instructs the target vehicle 1T to execute the “designated action”. More specifically, the management system 200 transmits instruction information INS for instructing the target vehicle 1T to execute the designated action. For example, the instruction information INS includes information on the content and pattern of the designated action assigned to the target vehicle 1T. Different actions may be assigned as the specified action for each target vehicle 1T (user). As another example, the content and the pattern of the designated action may be determined in advance and may be shared in advance by the target vehicle 1T.

The in-vehicle system 100 of the target vehicle 1T receives the instruction information INS from the management system 200 to perform instruction to execute the designated action. The in-vehicle system 100 of the target vehicle 1T executes the designated action in response to the instruction information INS.

One or more sensors 10 for recognizing (detecting) an action are disposed in the predetermined area AR. For example, a sensor 10 includes a camera for recognizing (detecting) a visible action. As another example, the sensor 10 may include a microphone for recognizing (detecting) an audible action.

The management system 200 can recognize (detect) an action executed by the vehicle 1 within the predetermined area AR by using the sensor 10. At the stage, since the target vehicle 1T has not been identified yet, the management system 200 recognizes (detects) an action executed by any vehicle 1 within the predetermined area AR. More specifically, the management system 200 acquires sensor detection information SEN detected by the sensor 10. The management system 200 recognizes an action executed by the vehicle 1 within the predetermined area AR based on the sensor detection information SEN. For example, the sensor detection information SEN includes an image captured by a camera. In the case, the management system 200 can recognize the visible action executed by the vehicle 1 based on the image. As another example, the sensor detection information SEN may include voice information detected by a microphone. In the case, the management system 200 can recognize the audible action executed by the vehicle 1 based on the voice information.

After the execution of the designated action is instructed to the target vehicle 1T, a determination period that is predetermined is provided. The determination period that is predetermined is set in consideration of communication delay, the duration of the specified action, and the like. During a determination period that is predetermined, the management system 200 determines whether any one of the vehicles 1 in the predetermined area AR has executed the designated action based on the sensor detection information SEN. When the management system 200 recognizes (detects) that the vehicle 1 in the determination period that is predetermined executes the designated action, the management system 200 identifies the vehicle 1 as the target vehicle 1T. That is, the management system 200 identifies the vehicle 1 that has executed the specified action within the determination period that is predetermined as the target vehicle 1T.

### 3. Vehicle Identification Processing Based on Plurality of Types of Actions

In some environments, the action executed by the vehicle 1 cannot be recognized well. For example, in a case where the action is blinking of the light, depending on the degree of the lighting, “overexposure” may occur in the image captured by the camera. In a case where the overexposure occurs in the image, there is a possibility that the blinking of the light by the vehicle 1 cannot be correctly detected even though the blinking of the light is performed. In a case where the action executed by the vehicle cannot be properly recognized, the target vehicle 1T cannot be identified.

Therefore, the present embodiment proposes a technology capable of increasing a probability of identifying the target vehicle 1T.

### 3-1. Summary

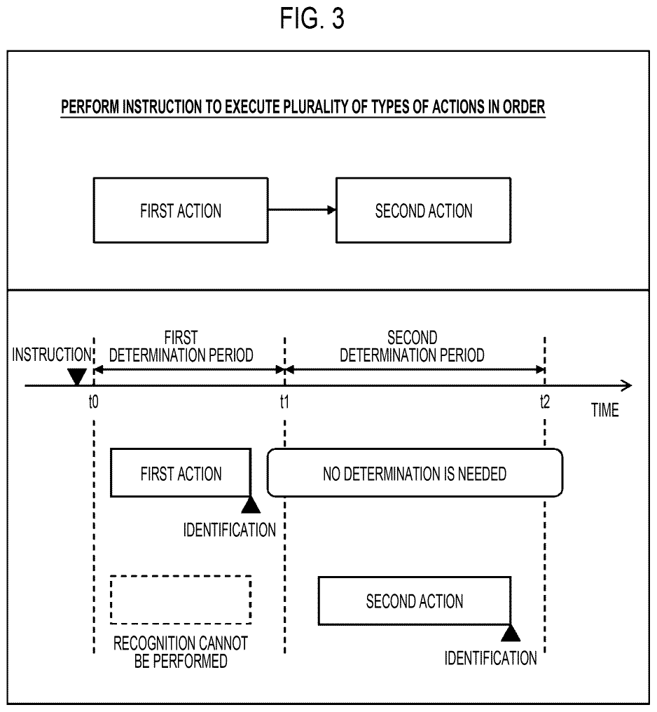

FIG. 3 is a conceptual diagram for describing an outline of the vehicle identification processing according to the present embodiment. According to the present embodiment, the management system 200 instructs the target vehicle 1T to execute a plurality of types of actions in a predetermined order. For example, the instruction information INS transmitted from the management system 200 to the target vehicle 1T includes information that specifies the contents of the types of actions and the order of the types of actions. The management system 200 uses the sensor 10 installed in the predetermined area AR to recognize an action executed by the vehicle 1 within the predetermined area AR. The management system 200 determines whether any one of the vehicles 1 in the predetermined area AR has executed any one of the types of actions. Then, the management system 200 identifies the vehicle 1 that has executed any one of the types of actions within the determination period after the instruction to the target vehicle 1T as the target vehicle 1T.

For simplicity, a case where the types of actions include a first action and a second action will be considered. The same applies even when the number of actions is three or more. The type of the first action and the type of the second action are different from each other. In addition, the first action is executed first, and the second action is executed after the first action. That is, the management system 200 instructs the target vehicle 1T to execute the second action after the first action.

The first determination period (from t0 to t1) is a determination period immediately after the instruction for the target vehicle 1T is performed, and is a period for recognizing the first action. The first determination period is set in consideration of communication delay, the duration of the first action, and the like. During the first determination period, the management system 200 determines whether any one of the vehicles 1 in the predetermined area AR has executed the first action based on the sensor detection information SEN. In a case where the management system 200 recognizes (detects) that the vehicle 1 in the first determination period executes the first action, the management system 200 identifies the vehicle 1 as the target vehicle 1T. That is, the management system 200 identifies the vehicle 1 that has executed the first action within the first determination period as the target vehicle 1T. In a case where the identification of the target vehicle 1T is successful, the target vehicle 1T does not need to execute the subsequent second action. Accordingly, the management system 200 may notify the target vehicle 1T that further execution of the action is not needed. That is, in a case where the identification of the target vehicle 1T is successful, the management system 200 may instruct the target vehicle 1T to stop executing the designated action. As a result, the execution of an action not needed is avoided.

On the other hand, in a case where the vehicle 1 that executes the first action within the first determination period cannot be recognized, the management system 200 executes the following processing. The second determination period (from t1 to t2) is a determination period following the first determination period, and is a period for recognizing the second action. The second determination period is set in consideration of the duration of the second action and the like. During the second determination period, the management system 200 determines whether any one of the vehicles 1 in the predetermined area AR has executed the second action based on the sensor detection information SEN. When the management system 200 recognizes (detects) that the vehicle 1 in the second determination period executes the second action, the management system 200 identifies the vehicle 1 as the target vehicle 1T. That is, the management system 200 identifies the vehicle 1 that has executed the second action within the second determination period as the target vehicle 1T.

As described above, according to the present embodiment, the target vehicle 1T is instructed to execute the types of actions in a predetermined order. Then, the vehicle 1 that has executed any one of the types of actions is identified as the target vehicle 1T. Even though a certain action is difficult to recognize under a certain environment, another action is likely to be easily recognized. That is, in any environment, at least any one of the types of actions is highly likely to be recognized. Therefore, the probability that the target vehicle can be identified is increased.

### 3-2. Example of Decision Method of Types of Actions

The types of actions may be decided in advance by a system designer. Alternatively, the types of actions may be flexibly determined in consideration of the equipment of the target vehicle 1T.

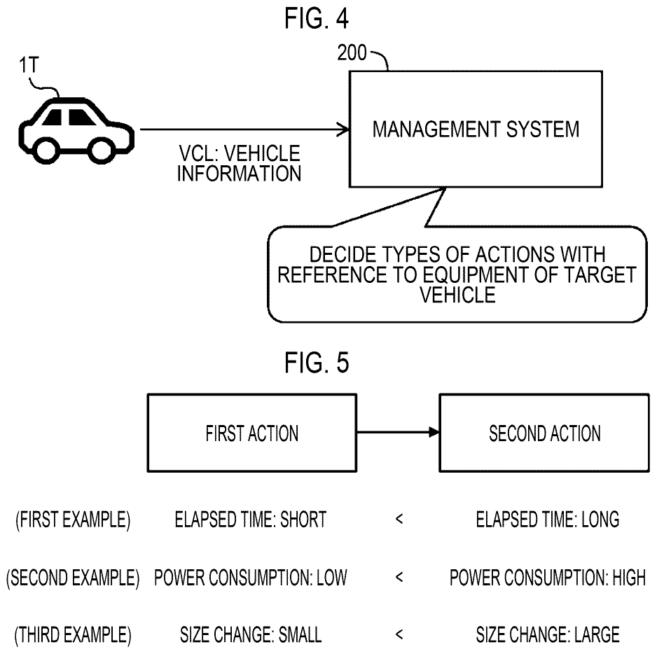

FIG. 4 is a conceptual diagram for describing an example of a method of deciding the types of actions. The in-vehicle system 100 of the target vehicle 1T provides vehicle information VCL regarding the target vehicle 1T to the management system 200. The vehicle information VCL includes vehicle equipment information indicating equipment of the target vehicle 1T. The equipment is the light or the actuator described above. The vehicle equipment information indicates a type of a light or an actuator included in the target vehicle 1T. The management system 200 recognizes an action executable in the target vehicle 1T and an action unexecutable in the target vehicle 1T based on the vehicle equipment information of the target vehicle 1T. The management system 200 excludes the unexecutable action from the candidates of the types of actions and configures the types of actions of the multiple types with the executable action.

### 3-3. Example of Order of Types of Actions

FIG. 5 is a conceptual diagram for describing an example of the order of the types of actions.

In the first example, the order of the types of actions is set from the viewpoint of the time needed. More specifically, a first time needed to execute the first action is shorter than a second time needed to execute the second action. For example, since the time needed for the door mirror opening and closing is longer than the time needed for the light blinking, the light blinking is set as the first action, and the door mirror opening and closing is set as the second action. As another example, since the time needed for opening and closing the door is longer than the time needed for opening and closing the door mirror, the door mirror opening and closing is set as the first action, and the door opening and closing is set as the second action. In the first example, since the actions are executed in order from the action with the shortest time, it is expected that the total time needed for identifying the target vehicle 1T is shortened.

In the second example, the order of the types of actions is set from the viewpoint of power consumption. More specifically, the first power consumption needed to execute the first action is lower than the second power consumption needed to execute the second action. For example, since the power consumption needed for the blinking of the light is higher than the power consumption needed for the opening and closing of the door mirror, the blinking of the light is set as the first action, and the opening and closing of the door mirror is set as the second action. As another example, since the power consumption needed for opening and closing the door is higher than the power consumption needed for opening and closing the door mirror, the door mirror opening and closing is set as the first action, and the door opening and closing is set as the second action. In the second example, the actions are sequentially executed from the action with the low power consumption, so that the total power consumption needed for identifying the target vehicle 1T is expected to be reduced.

In the third example, the order of the types of actions is set from the viewpoint of the change in the vehicle size. The vehicle size is the size of the appearance of the vehicle 1. More specifically, the change in the vehicle size caused by the execution of the first action is smaller than the change in the vehicle size caused by the execution of the second action. For example, since the change in the vehicle size caused by the opening and closing of the door mirror is larger than the change in the vehicle size caused by the light blinking, the light blinking is set as the first action, and the opening and closing of the door mirror is set as the second action. As another example, since the change in the vehicle size caused by the door opening and closing is larger than the change in the vehicle size caused by the door mirror opening and closing, the door mirror opening and closing is set as the first action, and the door opening and closing is set as the second action. In the third example, since the actions having a small change in the vehicle size are sequentially executed, the influence on the surrounding of the target vehicle 1T is suppressed.

### 3-4. Effects

As described above, according to the present embodiment, the target vehicle 1T is instructed to execute the types of actions in a predetermined order. Then, the vehicle 1 that has executed any one of the types of actions is identified as the target vehicle 1T. Even though a certain action is difficult to recognize under a certain environment, another action is likely to be easily recognized. That is, in any environment, at least any one of the types of actions is highly likely to be recognized. Therefore, the probability that the target vehicle can be identified is increased.

### 4. Configuration Example of Management System

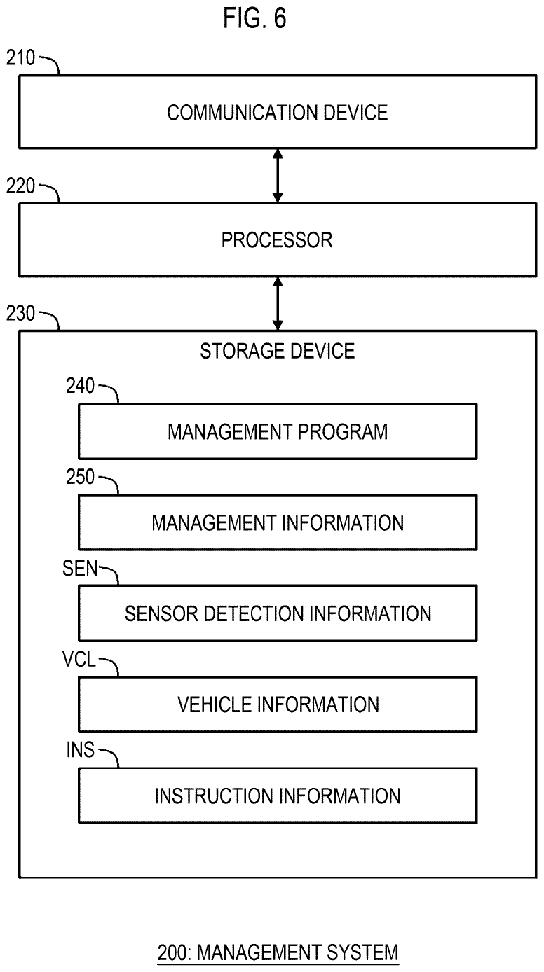

FIG. 6 is a block diagram showing a configuration example of the management system 200 according to the present embodiment. The management system 200 includes a communication device 210, one or more processors 220 (hereinafter, simply referred to as processor 220), and one or more storage devices 230 (hereinafter, simply referred to as storage device 230).

The communication device 210 communicates with the in-vehicle system 100 of each vehicle 1. In addition, the communication device 210 also communicates with the sensor 10 installed in the predetermined area AR. Further, the communication device 210 may communicate with the infrastructure camera CAM installed in the predetermined area AR.

The processor 220 executes various types of processing. Examples of the processor 220 include a general-purpose processor, a specific-purpose processor, a central processing unit (CPU), a graphics processing unit (GPU), an application specific integrated circuit (ASIC), a field-programmable gate array (FPGA), an integrated circuit, and/or a combination thereof. The processor 220 can also be referred to as processing circuitry. The storage device 230 stores various kinds of information. Examples of the storage device 230 include a volatile memory, a non-volatile memory, a hard disk drive (HDD), and a solid state drive (SSD).

A management program 240 is a computer program for managing the predetermined area AR. The functions of the management system 200 may be realized by the cooperation between the processor 220 that executes the management program 240 and the storage device 230. The management program 240 is stored in the storage device 230. The management program 240 may be recorded on a computer-readable recording medium.

The management information 250 is information for managing the predetermined area AR. The management information 250 is stored in the storage device 230. For example, the management information 250 includes the map information of the predetermined area AR. When the predetermined area AR is the parking lot PL, the management information 250 may include the usage status information indicating the usage status (vacancy status) of the parking frame in the parking lot PL. The processor 220 can allocate the empty parking frame (destination) to the target vehicle 1T based on the management information 250.

As still another example, the management information 250 may include vehicle management information for managing each vehicle 1 within the predetermined area AR. The vehicle management information includes a position of each vehicle 1 within the predetermined area AR. The processor 220 may perform communication with each vehicle 1 via the communication device 210 and collect the position information from each vehicle 1. Alternatively, the processor 220 may acquire the image captured by the infrastructure camera CAM installed in the predetermined area AR, and estimate the position of each vehicle 1 based on the image. The vehicle management information may include a traveling path TP assigned to each vehicle 1. The processor 220 can decide the traveling path TP assigned to each vehicle 1 based on the position information of the vehicle 1, the destination, and the map information.

One or more sensors 10 for recognizing (detecting) an action are disposed in the predetermined area AR. The processor 220 communicates with each sensor 10 via the communication device 210 to acquire the sensor detection information SEN detected by each sensor 10. The sensor detection information SEN is stored in the storage device 230.

The processor 220 may communicate with each vehicle 1 via the communication device 210 and collect the vehicle information VCL from each vehicle 1. The vehicle information VCL includes vehicle equipment information indicating equipment of the vehicle 1. The vehicle information VCL is stored in the storage device 230. The processor 220 may decide the types of actions to be assigned to the target vehicle 1T based on the vehicle equipment information of the target vehicle 1T.

In addition, the processor 220 generates the instruction information INS for the target vehicle 1T. The instruction information INS includes information that specifies the contents of the types of actions to be assigned to the target vehicle 1T and the order of the types of actions. The processor 220 transmits the instruction information INS to the target vehicle 1T by communicating with the target vehicle 1T via the communication device 210. The processor 220 determines whether any one of the vehicles 1 in the predetermined area AR has executed any one of the types of actions based on the sensor detection information SEN. The processor 220 identifies the vehicle 1 that has executed any one of the types of actions within the determination period after the instruction to the target vehicle 1T as the target vehicle 1T.

What is claimed is:

1. A management system that manages a vehicle in an area that is predetermined, the management system comprising one or more processors,
wherein the one or more processors are configured to:
instruct a target vehicle to execute a plurality of types of actions in an order that is predetermined;
recognize an action executed by the vehicle in the area that is predetermined by using a sensor installed in the area that is predetermined; and
identify the vehicle that has executed any one of the types of actions within a determination period after the instruction to the target vehicle, as the target vehicle.

2. The management system according to claim 1, wherein:
the types of actions include a first action and a second action different from the first action; and
the one or more processors are configured to instruct the target vehicle to execute the second action after the first action.

3. The management system according to claim 2, wherein a first time needed to execute the first action is shorter than a second time needed to execute the second action.

4. The management system according to claim 2, wherein a first power consumption needed to execute the first action is lower than a second power consumption needed to execute the second action.

5. The management system according to claim 2, wherein a change in vehicle size caused by the execution of the first action is smaller than a change in vehicle size caused by the execution of the second action.
